(19) United States
(12) Patent Application Publication
(10) Pub. No.: US 2014/0229476 A1
(43) Pub. Date: Aug. 14, 2014

(54) System for Information Discovery & Organization

(71) Applicant: SailMinders, Inc., Arlington, VA (US)

(72) Inventors: Hesham Fouad, Arlington, VA (US); Robert Cooper, Arlington, VA (US); John Stauffer, Silver Spring, MD (US)

(73) Assignee: SailMinders, Inc., Arlington, VA (US)

(21) Appl. No.: 14/177,242

(22) Filed: Feb. 11, 2014

Related U.S. Application Data
(60) Provisional application No. 61/764,655, filed on Feb. 14, 2013.

(51) Int. Cl. G06F 17/30

(52) U.S. Cl. CPC G06F 17/3087
USPC 707/729

(57) ABSTRACT

A system for searching the Internet for a document, comprises at least one computer system including, a first data repository, a second data repository and a processor. The first repository of data represents an organization of documents provided in response to frequency of terms found in individual documents. The second repository of data represents topics, with an individual topic being associated with, (a) a set of documents in the first repository and (b) a related topic. A processor is configured to, in response to a received search term, use the first and second repositories to identify search result documents in the organization of documents including documents from a first set of documents associated with the individual topic and a second set of documents associated with the related topic.

This is a non-provisional application claiming priority of provisional Application Ser. No. 61/764,655 by H. Fouad et al., filed 14 Feb. 2013.

### TECHNICAL FIELD

A system concerns online information search, discovery and retrieval by organizing documents by topic and content.

### BACKGROUND

The workplace is an environment where a primary asset used by workers is knowledge. Further, knowledge workers require access to high quality information on a variety of topics as dictated by a dynamic set of tasks. While the web has substantially increased the number of informational sources available to such workers, finding the right information at the right time remains difficult. The Internet is a source of a wealth of knowledge however the tools available for accessing the content are not well suited for knowledge acquisition. Search engines are a highly dynamic source of information and provide excellent coverage. The search results they produce, however, are optimized and presented based on a set of criteria that are not optimal for knowledge acquisition. Attempting to acquire knowledge using search engines is both time consuming, and may not produce good results. At the other end of the spectrum, online courses or Massive Online Open Courses (MOOC) provide education on a variety of topics (good coverage), but are static and time consuming. Known knowledge acquisition systems typically fail to find high quality information sources for a broad variety of relevant topics.

### SUMMARY

An online knowledge system locates high quality informational sources related to a particular topic by capturing intelligence of a multitude of user selections and user labelling using machine learning techniques. The system finds high quality information sources for a broad variety of relevant topics and organizes the sources to support learning, exploration, and collaboration. The system assesses suitability of information sources available to knowledge workers, based on evaluation criteria. The system categorizes information sources based on, (a) quality and whether a source provides high quality information, (b) coverage and whether a source provides content on a wide variety of topics and (c) dynamism and whether a source provides up to date information and provides it quickly.

A system for searching the Internet for a document, comprises at least one computer system including, a first data repository, a second data repository and a processor. The first repository of data represents an organization of documents provided in response to frequency of terms found in individual documents. The second repository of data represents topics, with an individual topic being associated with, (a) a set of documents in the first repository and (b) a related topic. A processor is configured to, in response to a received search term, use the first and second repositories to identify search result documents in the organization of documents including documents from a first set of documents associated with the individual topic and a second set of documents associated with the related topic.

### BRIEF DESCRIPTION OF THE DRAWINGS

FIG. 1 shows a system for searching the Internet for a document, according to invention principles.

FIG. 2 shows a flowchart of a process for adding documents to a document database, according to invention principles.

FIG. 3 shows a flowchart of a process for adding new topics to a topic database, according to invention principles.

FIG. 4 shows a flowchart of a process for associating a document with a topic, according to invention principles.

FIG. 5 shows a flowchart of a process for searching for documents (e.g. articles) relevant to a user entered search term (e.g. Food Safety), according to invention principles.

FIG. 6 shows a document database, according to invention principles.

FIG. 7 shows a topic database, according to invention principles.

FIG. 8 illustrates interaction between a topic Self Organizing Map (SOM) and a document SOM, according to invention principles.

FIG. 9-11 show user interface (UI) image windows provided by the system application enabling user interaction to support system operation, according to invention principles.

FIG. 12 shows Topic locations on the Topic SOM after training, according to invention principles.

FIG. 13 shows Document locations on the Document SOM after training, according to invention principles.

FIG. 14 shows predetermined relevance radii for beginner, intermediate and expert users in a document SOM determined in response to calculated Topic IQ, according to invention principles.

FIG. 15 shows a Table derived using document and topic SOMs and listing documents and their corresponding spatial distances from a calculated Feature Vector of each of two topics, according to invention principles.

FIG. 16 shows a representation of a SOM, according to invention principles.

FIG. 17 shows a flowchart of a process used by a system for searching the Internet for a document, according to invention principles.

### DETAILED DESCRIPTION

A system assesses information quality provided by an online source, organizes sources in a topic based ordering that supports knowledge acquisition and exploration, and enables labelling the organized structure based on its topic areas. A Self Organizing Map as used herein is a low-dimensional (typically two-dimensional), discretized representation of the input space of the training samples, called a map. As used herein the term “repository” is used interchangeably with the term “database”. As used herein a document comprises an informational source, text, message, compilation of data, image, picture or software code and is used interchangeably with the term “article”. As used herein a Feature Vector comprises data indicating a document spatial position within an array of elements representing documents.

The system provides a “search by example” function whereby a user identifies a document, and the system finds documents and/or topics that are relevant to that document. The system derives a Feature Vector from a document and individual Feature Vectors constitute a point in Feature Space. The system finds documents and/or topics that are relevant to a document in response to a derived Feature Vector of the document. The system extracts terms from a document along with a measure of their relevance to the document. The relevance measure is derived from the context of the document. The system derives the Feature Vector from the extracted terms and their respective relevance values using a hashing function that is a one way mapping.

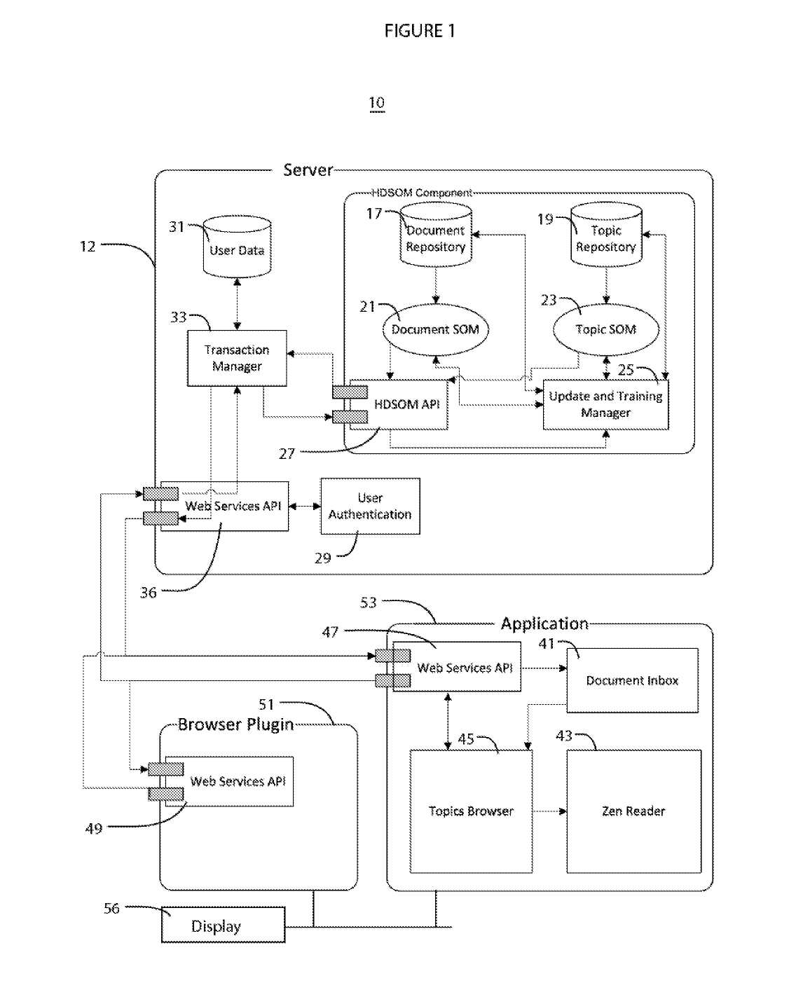

FIG. 1 shows a system 10 comprising at least one computer system for searching the Internet for a document. System 10 includes a server system 12, browser plugin 51 and Application 53 bidirectionally intercommunicating via web services API (Application Programming interfaces) 36, 49 and 47. Browser plugin 51 is used in conjunction with a client computer and browser and supports web based UI (user interface) interaction between Application 53 and server 12. Although shown as separate units, server system 12, browser plugin 51 and Application 53 may be resident on a single computer system or distributed across different computer systems that may be remotely located from each other. Further, server system 12, browser plugin 51 and Application 53 may in an embodiment comprises software functions executed on a single processor or multiple different processors such as by topics browser 45, transaction manager 33, update and training manager 25 and plugin 51. In addition units 12, 51 and 53 include data repositories (not shown) supporting function operation.

Application 53 includes inbox 41 for receiving and storing documents and includes topic browser 45 enabling a user to add, delete, edit and navigate document topics as well as to associate a received document with one or more existing or new topics. Reader 43 supports document reading and processing for presentation on a display unit (not shown). Server 12 supports document related search and database update functions. In response to UI commands via Application 53 and browser plugin 51, transaction manager 33 determines user access and authorization (e.g., in response to a password and userid) using authorization unit 29 and user data stored in repository 31. Transaction manager 33 operating together with database and training manager 25 via API 27, directs generation and update of a document database 17 and associated document SOM data array 21 as well as a topic database 19 and associated topic SOM data array 23. Unit 33 with unit 25, stores in a first repository 21 data representing an organization of documents (e.g. a 2D (two dimensional) SOM map comprising a data array of spatially organized individual elements representing corresponding individual documents) provided in response to frequency of terms found in individual documents. Unit 33 with unit 25, stores in a second repository 23 data representing topics (e.g. a 2D (two dimensional) SOM map comprising a data array of spatially organized individual elements representing corresponding individual topics associated with corresponding documents). Further, an individual topic is associated with, (a) a set of documents in the first repository 21 and (b) a related topic. A processor (units 33 and 25) is configured to, in response to a received search term, use the first and second repositories 21 and 23 to identify search result documents in the organization of documents 17 and including documents from a first set of documents in unit 17 associated with the individual topic and a second set of documents associated with the related topic. Search results and UI windows supporting user interaction and operation of system 10 are presented on display 56

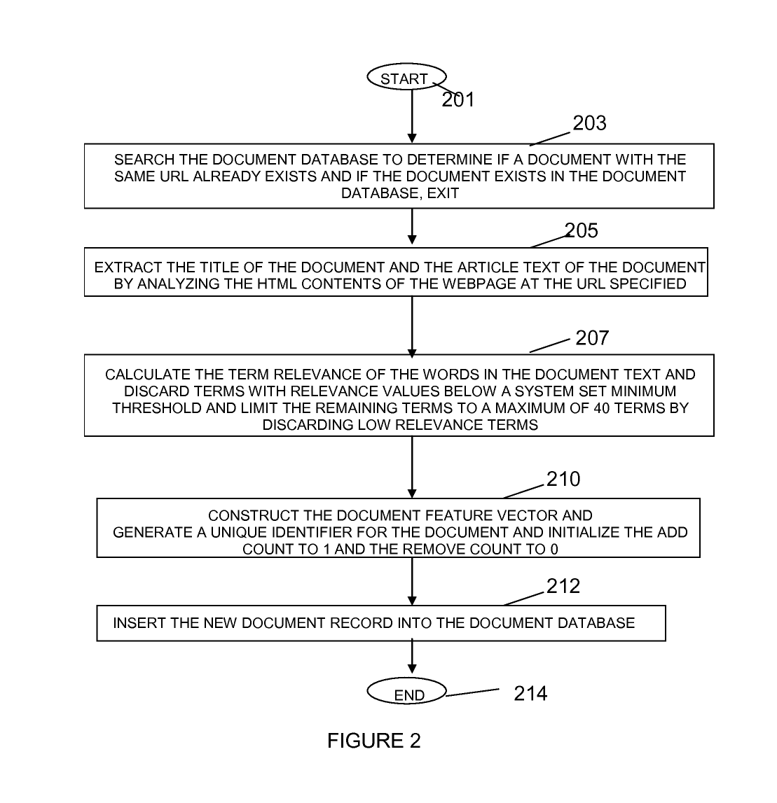

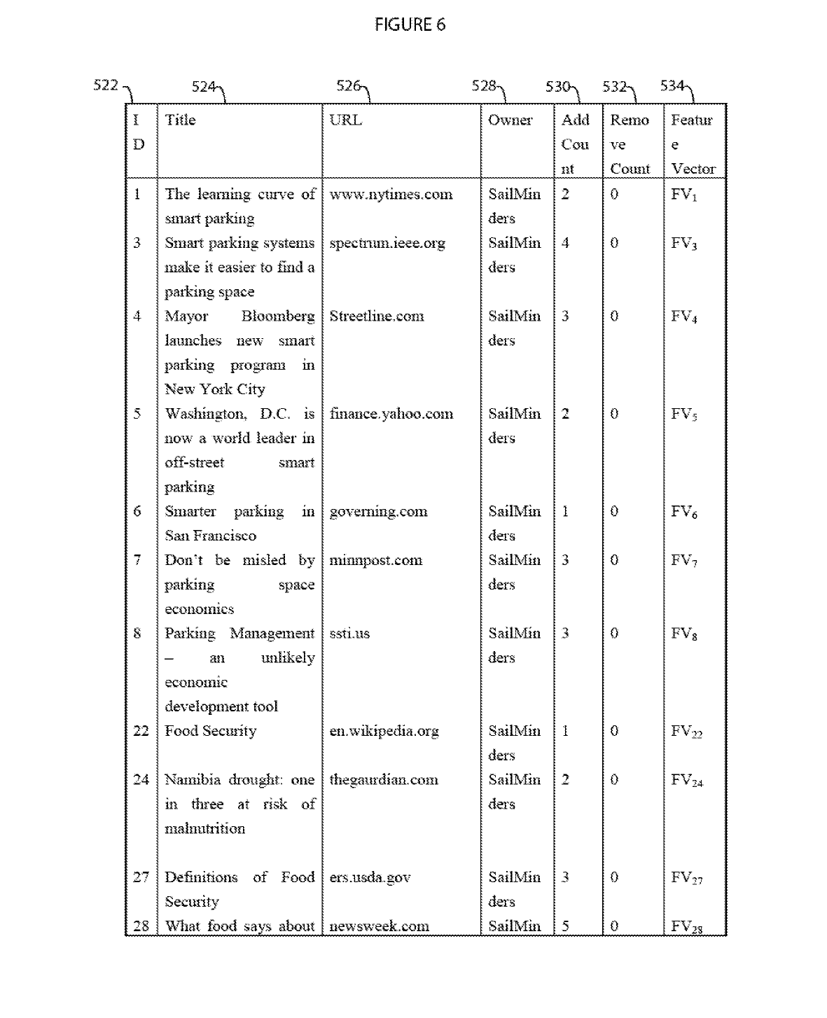

FIG. 2 shows a flowchart of a process for adding documents to document database 17. Document repository 17 is a database comprising documents that have been selected by users in their use of system 10 as well as the corpus of documents used for initial training FIG. 6 shows document repository 17 where an individual record in the repository comprises Unique Identifier 522, Document title 524, Document source URL 526, Document owner 528, Add Count 530, Remove Count 532, and Feature Vector 534. In activity 203 (FIG. 2) following the start at step 201, in response to a document being acquired in inbox 41 together with a source URL and the identity of the user adding the document (Owner), units 33 and 25 search document repository 17 to determine if a document with the same URL already exists and if the document exists in the Document Database, the process of FIG. 2 terminates. As used herein units 33 and 25 operate in conjunction as a computer processing unit executing stored instruction or as logic devices to perform functions but may also in other embodiments act individually to perform a function. In activity 205, units 33 and 25 extract the title and text of the Document by analyzing the HTML contents of the Webpage at the URL specified, for example. Units 33 and 25 in activity 207 calculate the term relevance of the words in the Document Text and discard terms with relevance values below a system 10 minimum threshold and limit the remaining terms to a maximum of 40 terms, for example, by discarding low relevance terms. In activity 210 units 33 and 25 generate the document's Feature Vector, and a new, unique identifier for the Document and initializes the Add Count to 1 and the Remove Count to 0. Units 33 and 25 insert the new Document record into the Document repository 17. Documents are typically not completely removed from the database. When a user removes a document from a user topic, the documents database entry is updated, but the document record is not removed. Unit 33 and 25 search the Document Database 17 to determine if a document with the same URL exists and if so the Document Database Remove Count is incremented by 1. The process of FIG. 2 terminates at activity 214.

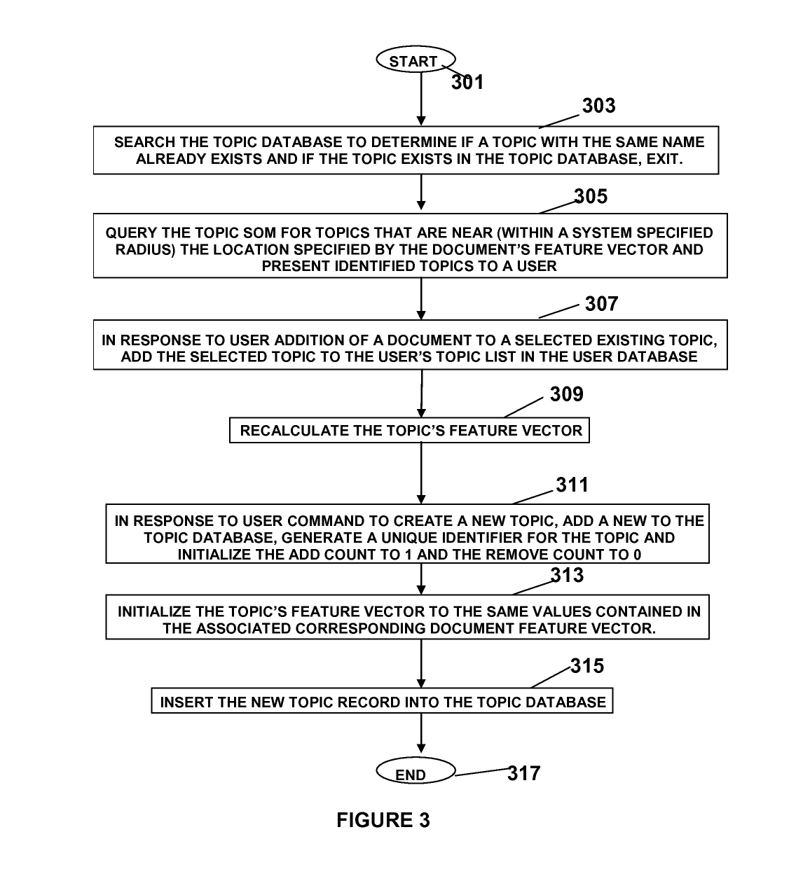

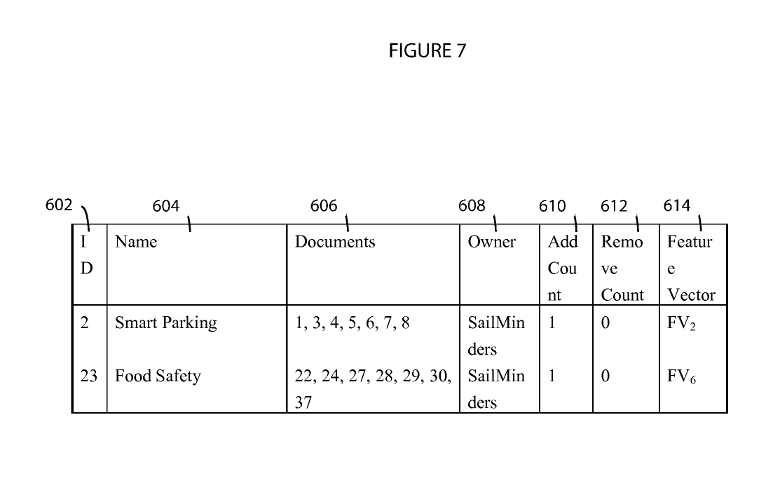

FIG. 3 shows a flowchart of a process for adding new topics to a topic database. In order to add a new Topic to Topic Database 19 a user enters a topic name, data indicating the identity of the user creating the topic, and a document to be associated with the topic. User addition of a topic reduces redundant topic creation. In activity 303 following the start at activity 301, units 33 and 25 search Topic Database 19 to determine if a topic with the same name of a topic to be added already exists and if the topic exists in the Topic Database, the process terminates. FIG. 7 shows topic database 19 comprising a repository containing data identifying topics created by users as well as the topics created for initial training of a SOM. A topic record in the database includes a Unique Identifier 602, Topic Name 604, Member Documents 606, Topic Owner 608, Add Count 610, Remove Count 612, and Feature Vector 614.

A Feature Vector comprises, for example, a one-dimensional matrix of decimal numbers that describes the lexical content of a text document. A Feature Vector, in an embodiment, associates an individual cell of the vector with a word from the English language. In order to limit the size of the vectors, stemming is used to eliminate grammatical variations of the same word (such as run and running) and commonly occurring words such as connectives (for example if, while, so, but, yet) are excluded. In order to construct a Feature Vector for a given document, the importance or relevance of each word represented in the Feature Vector is determined for the target document. The use of frequency of a word in a document (term frequency) comprising the number of occurrences of the word in the document, to determine a word's relevance to a document is limited for discriminating between documents if the word occurs frequently in the documents being classified. Therefore, a Feature Vector employs inverse document frequency, which gives higher scores to words that occur frequently in a small number of documents in a collection of documents. If N is the number of documents in a collection, inverse document frequency is calculated as

$${idf}_{t} = log \frac{N}{{df}_{t}}$$

where dfₜ is the document frequency of term t, the number of documents in which term t occurs. Term relevance assigned by units 33 and 25 to each term in a Feature Vector combines both term frequency and inverse document frequency as follows:

weightₜ=tfₜ×idfₜ

Units 33 and 25 select relevant words of a document to include in a Feature Vector reducing the number of words in the vector and advantageously use a non-cryptographic hash function to map relevant words found in a document to cell indices in a Feature Vector. This also advantageously reduces computational overhead in obtaining, maintaining, and storing large collections of terms especially when multiple languages are supported. The hash function used acquires an input string of characters, and outputs an integer number, the hash number, that uniquely identifies the input string within the precision provided by the range numbers that the function outputs. Hash functions, therefore, do not guarantee that two different input strings will produce different hash numbers. The approach, termed feature hashing, obviates the need to maintain large dictionaries of words and provides a computationally efficient method of constructing Feature Vectors from text documents. The feature vector hashing does not significantly impair classification performance.

Units 33 and 25 in activity 305 query the topic SOM 23 for topics that are near (within a predetermined radius) of a location in the topic SOM map 23 determined by a document's Feature Vector and presents identified topics to a user in an image on display 56. If topics are found near the document in the topic SOM map 23, they are presented to the user as candidate topics that the user can associate the document with. A user also is presented with an option of not choosing the candidate topics and creating a new one. In activity 307, in response to user addition of a document to a selected existing topic, the selected topic is added to the user's topic List in the User Database and is subsequently displayed in the Application's topic area. Units 33 and 25 in activity 309 recalculate the topic's Feature Vector as a mean value of the Feature Vectors of the Documents in the new Document list as follows:

$${FV}_{topic} = \frac{{\sum }_{i = 1}^{N} {FV}_{i}}{N}$$

Where N is the number of Documents in the new Document list and FVᵢ is the Feature Vector of the i^{th} Document in the topic's document list.

In response to user command to create a new topic, in activity 311 a new record is added by units 33 and 25 to topic Database 19, a new, unique identifier for the topic is generated and the Add Count is initialized to 1 and the Remove Count is initialized to 0. In activity 313 the added topic's Feature Vector is initialized to the same values of the associated corresponding Document Feature Vector and in activity 315 units 33 and 25 insert the new topic record into topic Database 19. The process of FIG. 3 terminates at activity 317.

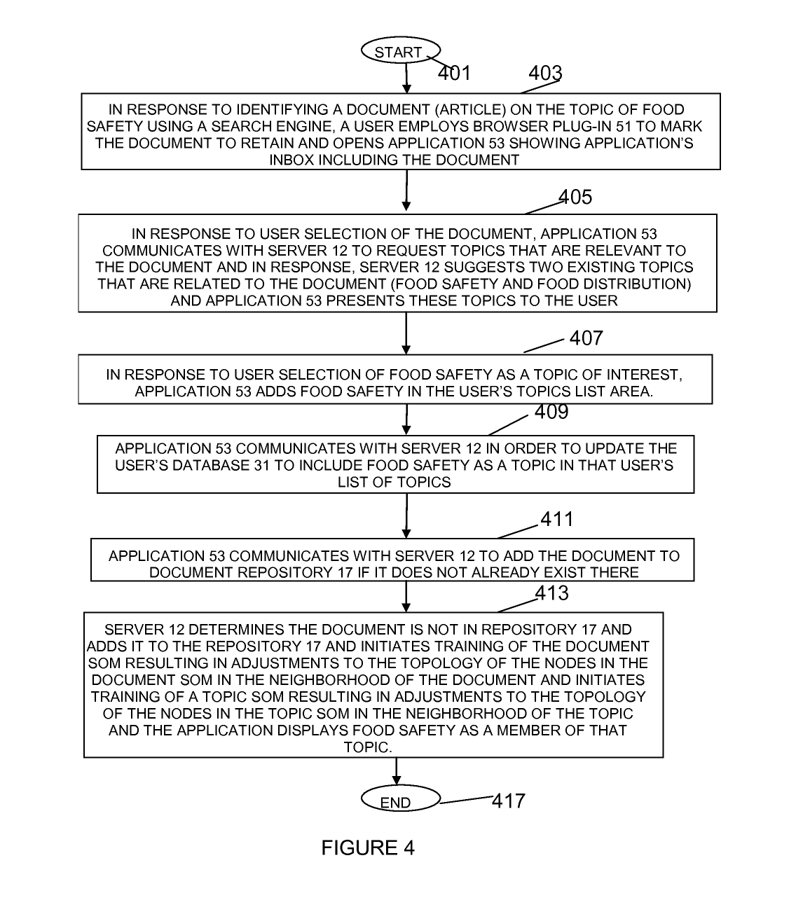

FIG. 4 shows a flowchart of a process for associating a document with a topic. In activity 403 following the start at step 401, in response to identifying a document (article) on the topic of food safety using a search engine, a user employs browser plug-in 51 to mark the document to retain and opens Application 53 showing inbox 41 including the document. In activity 405 in response to user selection of the document, Application 53 communicates with Server 12 to request topics that are relevant to the document and in response, Server 12 suggests two existing topics that are related to the document (Food Safety and Food Distribution) and Application 53 presents these topics to the user. In activity 407, in response to user selection of Food Safety as a topic of interest, Application 53 adds Food Safety in the User's topics List area. Application 53 in activity 409 communicates with Server 12 in order to update the user's database 31 to include Food Safety as a topic in the user's list of topics. Application 53 in activity 411 communicates with Server 12 to add the document to document repository 17 if it does not already exist there. Server 12 in activity 413 determines the document is not in repository 17 and adds it to the repository 17 and initiates training of Document SOM 21 resulting in adjustments to the topology of the nodes in the Document SOM in the neighborhood of the document. Server 12 adds the document to the Food Safety topic by adding it to the list of articles associated with the topic and recalculating a feature vector for that topic as the mean of the feature vectors of documents associated with that topic. Server 12 initiates training of a topic SOM resulting in adjustments to the topology of the nodes in the topic SOM in the neighborhood of the topic. The Application displays Food Safety in the user's topic List area with the document as a member of that topic.

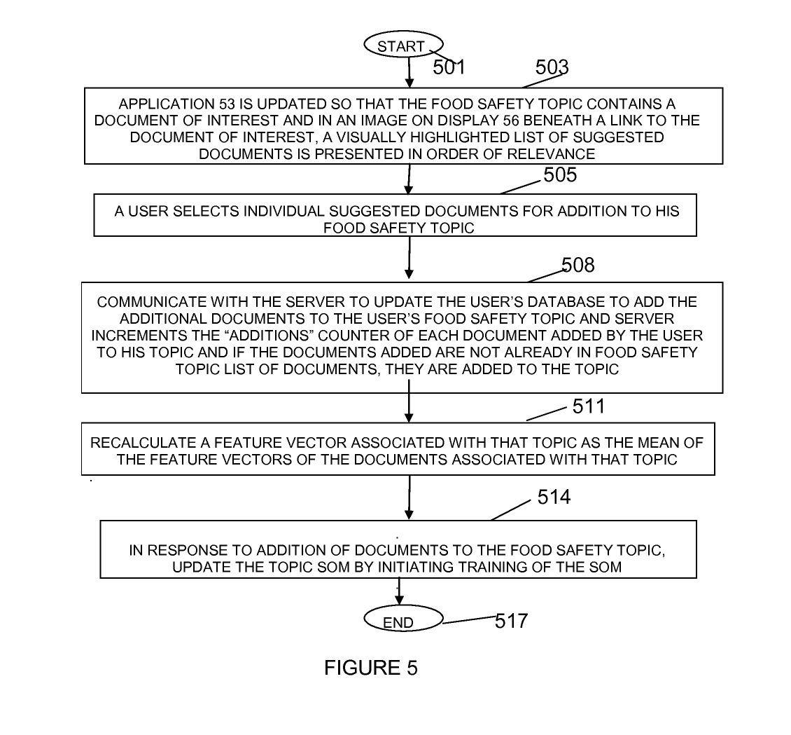

FIG. 5 shows a flowchart of a process for searching for documents (e.g. articles) relevant to a user entered search term (e.g. Food Safety). In response to an Application 53 request to Server 12 for a list of documents relevant to Food Safety, units 33 and 25 determine a maximum spatial distance on a Document SOM 21 data map (array) that indicates the degree of relevance required and Server 12 queries the Document SOM for articles with a specified distance of a current feature vector of the Food Safety topic and Server 12 returns the list of documents to the Application 53. Units 33 and 25 determine a maximum spatial distance using a Vector Space Model to organize and navigate a collection of documents using a metric that measures the relative proximity of documents in vector space. This metric is used in training Document SOM 21 in locating documents related to a topic, and in locating topics relevant to a document.

Feature Vectors specify points in N-space where N is the size of the Feature Vector and a metric that may be used is a Euclidean distance between two points. Euclidean distance d between two Feature Vectors is calculated using, for example,

$$d = \sqrt{{\sum }_{i = 1}^{N} {fv}_{i}^{2}}$$

where fvᵢ is the i^{th} element of Feature Vector fv. Another commonly used proximity metric is a cosine of the angle between two Feature Vectors. This metric is calculated using the dot product vector operation. This metric advantageously preserves dot products between Feature Vectors when feature hashing is used, while Euclidean distance may not be. The dot product metric to calculate the proximity metric between two Feature Vectors is determined using,

$$p = {\sum }_{i = 1}^{N} fv {1}_{i} \times fv {2}_{i}$$

In activity 503 following the start at activity 501, Application 53 is updated so that the Food Safety topic contains a document of interest and a list of suggested visually highlighted documents in order of relevance is presented in an image on display 56 beneath a link to the document. A user is able to view each of the recommended documents on display 56 by double clicking on a link to each one in turn to view the corresponding document in a separate area of the displayed image.

In activity 505, a user selects an individual suggested document for addition to his Food Safety topic by selecting an Add “+” button next to the documents. Application 53 in activity 508 communicates with Server 12 to update user database 31 to add the additional documents to the particular user's Food Safety topic and Server 12 increments the “Additions” counter of each document added by the user to his topic. If the documents added are not already in Food Safety topic list of documents, they are added to the topic. In activity 511, units 33 and 25 recalculate a feature vector associated with that topic as the mean of the feature vectors of the documents associated with that topic. In activity 514, in response to addition of documents to the Food Safety topic, topic SOM 23 is updated by initiating training of the topic SOM 23.

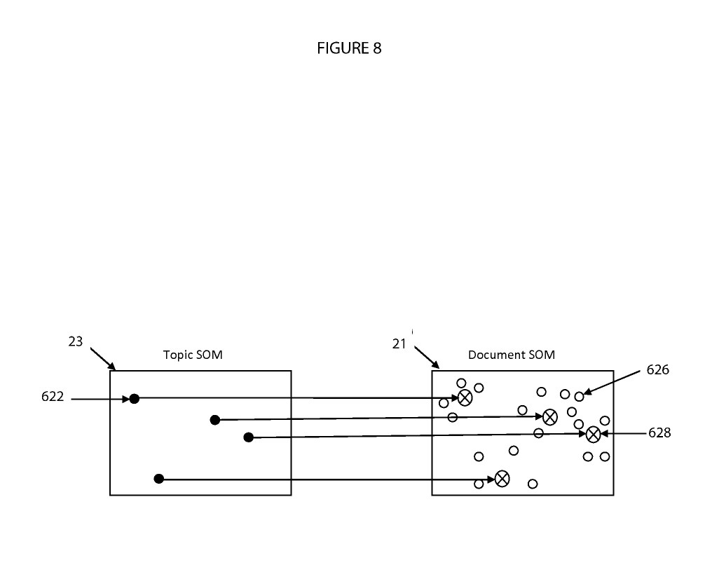

FIG. 8 illustrates interaction between topic Self Organizing Map (SOM) 23 and document SOM 21. topic SOM 23 shows labeled topical areas including topic 622 and document SOM 21 shows online informational sources including document 626 and topic mapping point 628. Nodes in topic SOM 23 represent topics that have been created by users. Nodes in document SOM 21 represent documents (informational sources) that users indicate incorporate high value information related to a topic. Individual nodes in the topic SOM 23 correspond to a location in the Document SOM 21. A corresponding location in document SOM 21 is derived in response to mean of the term frequency feature vectors of the documents that are associated with a topic by users thus determining a neighborhood of documents for each topic. System 10 advantageously identifies high value documents from the multitude of documents available online based on intelligence gathered from a base of users. Further, system 10 organizes the documents into topical groups that are topically labeled by a base of users by selecting and labeling groups of high value documents online.

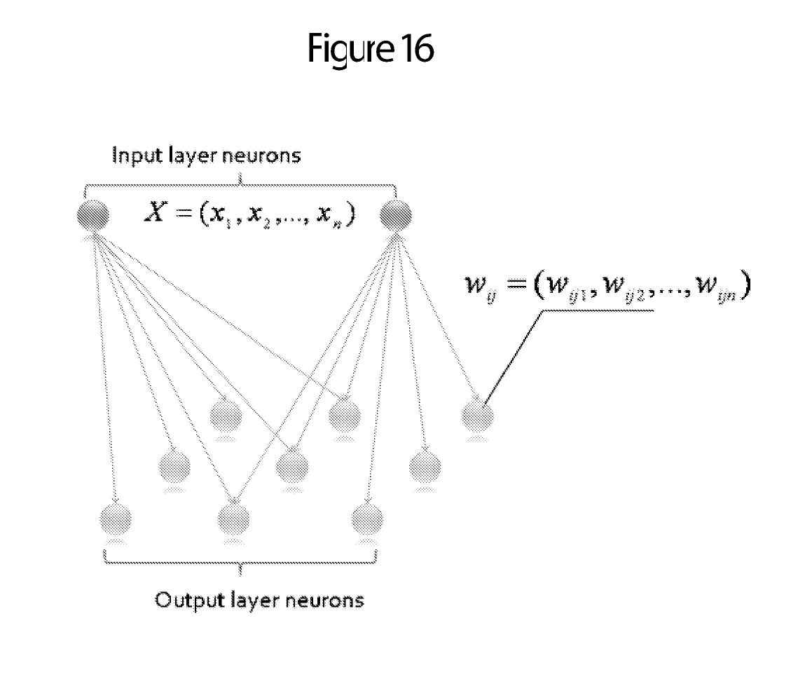

FIG. 16 shows a representation of a SOM for classifying text documents based on their content. A Self Organizing Map is a special type of a biologically inspired machine learning method called an Artificial Neural Network (ANN) that is trained using unsupervised learning to produce a low-dimensional (typically two-dimensional), discretized representation of the input space of the training samples, called a map. Self-organizing maps are different from other artificial neural networks in that they use a neighborhood function to preserve the topological properties of the input space. The training process of SOM 21 and 23 involves presenting the network with training data consisting of a set of n-dimensional feature vectors. For document classification, those vectors are the term frequencies of each document indicating the frequency (and number of occurrences) of particular terms (words or phrases) that appear in a document. Each node in the network also contains an n-dimensional feature vector that is initially populated with random values. On each iteration of training, the network is presented with a single feature vector. The node with a feature vector closest in value to the training vector is selected as a winner node and its feature vector is adjusted so that its value moves closer to the training vector. The vectors of the neighboring nodes are also adjusted towards the training vector, but by progressively smaller amounts depending on their distance from the winner node. The SOM includes an input layer X (x1, x2 . . . xn) that is connected to the nodes in the SOM however there is no output from the output neurons. Each node has a Weight vector Wij that represents its position in Feature Space.

The SOM competitive learning selects a single node as a winner and it is guaranteed to converge to a stable state. It results in a network self organizing itself into a low dimensional structure that reflects the topological structure of high dimensional data and results in a two dimensional map (SOM 21 and 23) where each node represents a set of related documents (and topics) and the relative location of the nodes (measured as a combination of the Euclidean distance and the cosine of the angle between the feature vectors of two nodes) reflects the topical relationship of the documents. Nodes that are near each other indicate documents that are topically related while nodes that are far from each other are topically unrelated. System 10 stores a taxonomy of topics and high value information sources associated with the topics and uses SOM 21 and 23 to capture intelligence in a form that is both accessible to the user and that can grow serially to capture the intelligence of a user base.

The SOMs comprises a two level hierarchical SOM with one level including documents selected by a user base. Document SOM 21 organizes documents based on their term frequency. The second level SOM 23 contains nodes that correspond to topics created by users. When a topic is created by a user, it initially does not have a term frequency vector assigned to it. As documents are added to that topic, the term vector for that node is assigned to be the mean of the term vectors of its constituent documents. This creates a correlation between the two levels of SOM. Each node in the topic SOM is anchored to a location in the Document SOM. The neighborhood of that anchor contains the documents most relevant to that topic. This organizes topics created by users into neighborhoods of related topics.

System 10 supports browsing documents and topics using document SOM 21 enabling size of a neighborhood to be dynamically changed to include more or less documents and topic SOM 23 enabling size of a neighborhood to be dynamically changed to include more or less topics. Browsing documents related to a topic involves selecting a topic including documents added by other users in a topic neighborhood of a document. Browser plug-in 51 enables users to select an open document for addition to a topic. System 10 displays topics and their associated documents and provides access through a set of web services by third party applications through a web services interface.

A Self Organizing Map (SOM) is represented as a two dimensional array of nodes. Each node consists of a data structure containing a Feature Vector and a list of the Data Observations (a Data Observation can be either a Document Identifier or topic Identifier depending on what the SOM represents) that are nearest in distance to that node's Feature Vector. The elements comprising this list are referred to as the Best Matching Units (BMUs). SOM 21 or 23 is trained in an iterative manner where each iteration of training brings the SOM closer to a stable state where its topology reflects the topical structure of the input Data Observations. SOM training begins by assigning each node a Feature Vector consisting of random values and initializing the list of BMUs to an empty list. In a training iteration, units 33 and 25 select a random Data Observation (Document or topic) from the database (units 17 and 19) and calculate the distance between the Data Observation's Feature Vector and the Feature Vectors of the SOM cells. Units 33 and 25 select the SOM cell with the smallest distance to the Data Observation as a winning cell

and modifies the Feature Vector of the winning cell by adding to it a vector quantity equal to the difference between the two Feature Vectors multiplied by a scalar value representing the current learning rate so that the cell moves closer to the Data Observation. Units 33 and 25 modify the Feature Vector of other cells in the SOM by adding to their Feature Vector a vector quantity equal to the difference between each cell's Feature Vector and the Data Observation's Feature Vector multiplied by a scalar value representing the neighbor cell influence so that the cell moves closer to the Data Observation. The learning rate scalar value controls the magnitude of changes that are made to SOM during training. At the start of training it is set to a relatively large number but is progressively reduced as training proceeds and the SOM approaches a stable state. Units 33 and 25 calculate the learning rate scalar as,

$$lr = {lr}_{initial} \times {( \frac{{lr}_{final}}{{lr}_{initial}} )}^{\frac{{i}_{current}}{{i}_{total}}}$$

Where lr is the learning rate used in the current training iteration, lrᵢₙᵢₜᵢₐₗ is the learning rate at the start of training, lr_{final} is the learning rate at the end of training, i_{current} is the current training iteration and i_{final} is total number of training iterations.

The neighbor cell influence is a scalar value that controls how much influence a winning cell has on its neighbors. This value is highest near the cell and falls off exponentially away from the cell. The cell influence scalar is calculated as,

$$ni = exp ( \frac{- {d}_{cell} \times {d}_{cell}}{2 \times {( {{ni}_{initial} ( \frac{{ni}_{final}}{{ni}_{initial}} )}^{\frac{{i}_{current}}{{i}_{total}}} )}^{2}} )$$

Where ni is the neighbor influence used in the current training iteration, d_{cell} is the distance in Cartesian coordinates between the winning cell and a neighboring cell, niᵢₙᵢₜᵢₐₗ is the maximum value of the neighbor influence scalar applied to immediate neighbors of the winning cell, ni_{final} is the minimum value of the neighbor influence scalar, i_{current} is the current training iteration and i_{final} is the total number of training iterations. The distance between two cells in a SOM depends on the topology of the SOM. System 10 uses a two dimensional grid, so the distance between celli located at (rowᵢ, colᵢ) and cell j located at (rowⱼ, colⱼ) is calculated as the Manhattan distance between the cells:

d=(|rowᵢ−rowⱼ|)+(|columnᵢ−columnⱼ|)

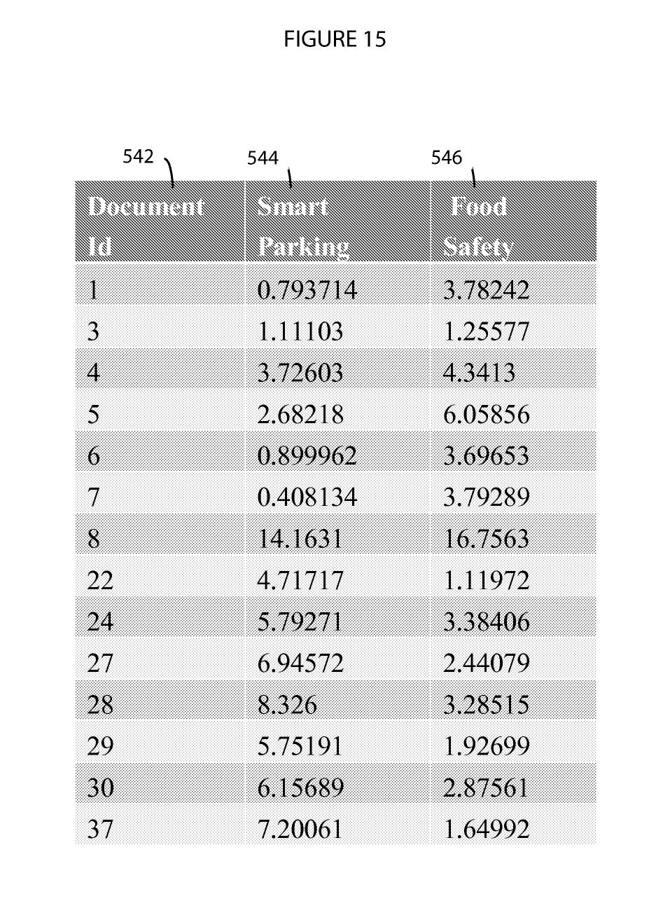

FIG. 15 shows a Table derived using document and topic SOMs (21 and 23) and listing documents in column 542 and their corresponding spatial distances from the calculated Feature Vector of each of two topics (Smart Parking in column 544 and Food Safety in column 546). Documents related to Smart Parking (rows 1, 3, 4, 5, 6, 7, 8) are closer to the Smart Parking topic, while documents related to Food Safety (rows 22, 24, 27, 28, 29, 30, 37) are closer to the Food Safety topic.

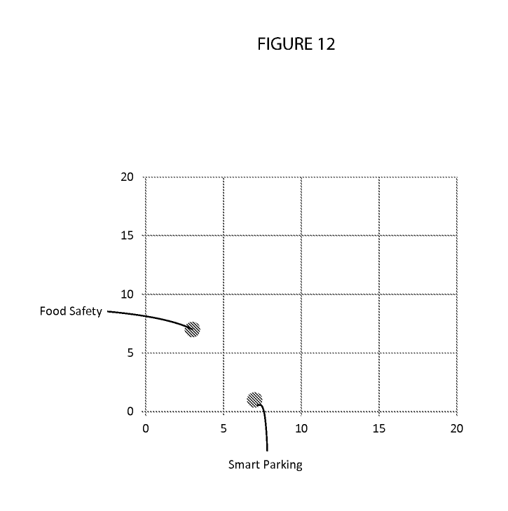

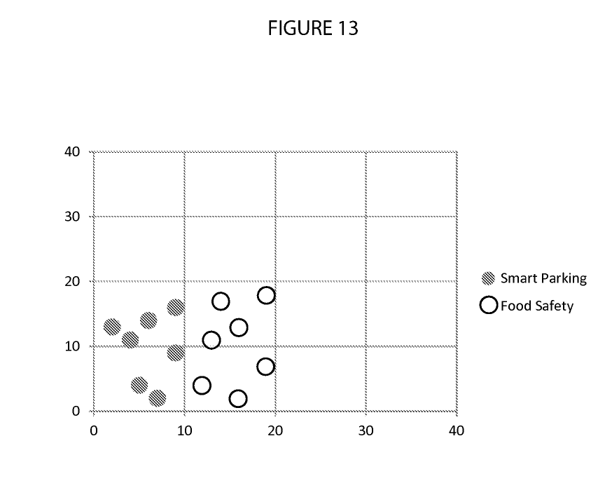

FIG. 12 shows spatial topic locations on the topic SOM including Food safety and Smart Parking topics following SOM training FIG. 13 shows spatial Document locations on the Document SOM illustrating the documents in the Document SOM are clustered in neighboring cells after training. There is no correlation between topic locations and document locations on the two SOMs, the important information provided by the SOM organization is the relative locations of the topics and documents. Both the Document SOM and the topic SOM exhibit the expected clustering of the documents and topics based on their Feature Vectors.

System 10 enables advantageous querying of documents and topics, for example, to find topics related to a document, documents related to a topic, topics related to a topic, as well as documents related to a document. Individual queries may comprise a radius of relevance (spatial distance) from a point of reference on SOM 21 and SOM 23. This advantageously allows users to control the specificity of the results returned. Units 33 and 25 find relevant topics within a specified radius of relevance from a target document using SOM 21 and SOM 23. The selected radius determines the breadth of relevant topics. A user adds a new document to inbox 41 using browser plug-in 51 and selects a topic and units 33 and 25 prompt a user with a topic radius. Units 33 and 25 thereby use a radius to suggest a set of existing topics and advantageously limit the number of extraneous topics created by users. Units 33 and 25 calculate the spatial distance between a Feature Vector of a document and a Feature Vector of a selected topic node in topic SOM 23. If the distance is less than the specified radius, units 33 and 25 add the topics from the node's Best Matching Unit list to the result.

System 10 finds relevant documents within a specified radius of relevance from a target topic using SOM 21 and SOM 23 to suggest documents relevant to a topic. System 10 derives a query to provide a document recommendation allowing users to quickly build their topic content by adding documents from a list of recommended documents to a user document or search. For each node in document SOM 21, units 33 and 25 calculate a distance between a topic Feature Vector and a selected node Feature Vector. If the distance is less than a specified radius, units 33 and 25 add the Documents from the node cell's Best Matching Unit list to the result.

System 10 finds relevant topics within a specified radius of relevance from a target topic using SOM 21 and SOM 23 and derives a query enabling users to browse a topical neighborhood of the topic SOM 23. For each cell in topic SOM 23, units 33 and 25 calculate the distance between the topic Feature Vector and the selected cell Feature Vector. If the distance is less than the specified radius, units 33 and 25 add the topics from the cell Best Matching Unit list to the result.

System 10 finds relevant documents within a specified radius of relevance from a target document using SOM 21 and SOM 23 and derives a query enabling users to browse a topical neighborhood of document SOM 21. For each cell in document SOM 21, units 33 and 25 calculate the distance between the document Feature Vector and the selected cell Feature Vector. If the distance is less than the specified radius, units 33 and 25 add the documents from the cell Best Matching Unit list to the result.

System 10 advantageously determines user time varying level of expertise (topic IQ) in a topic area and displays user expertise level for a given topic on display 56. Units 33 and 25 calculate a user's topic IQ using a ratio of documents that exist within a fixed radius of a topic′ Feature Vector location on Document SOM 21 and the number of those documents read by the user.

$$TopicIQ = \frac{\# documents read}{\# documents related to topic}$$

Units 33 and 25 calculate a number of documents related to a topic based on the inherent organization of the SOM 21 and 23 structure. A topic Feature Vector includes topic location or “anchor” in document SOM 21. In order to determine the number of documents related to a given topic, units 33 and 25 finds documents that fall within a predetermined distance of the topic Feature Vector. The predetermined distance used in the topicIQ calculations can be automatically and dynamically varied based on the level expertise that a user has achieved. For a novice user, that distance can be relatively small. Once the user has achieved a high topicIQ score as a novice, units 33 and 25 move the user to Intermediate status and the distance used in the topicIQ calculation is increased. In response to the user achieving a high score at the Intermediate level, the user is moved to Expert status and the distance is increased further.

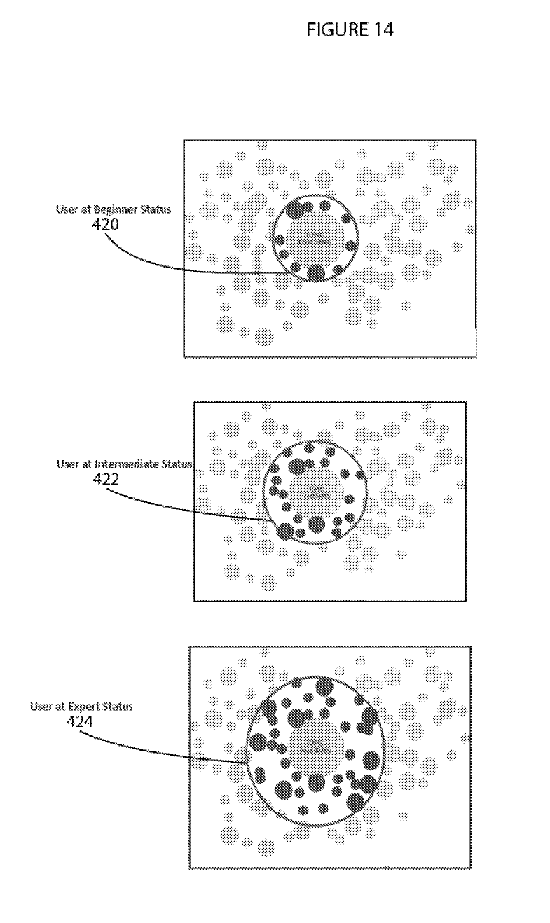

FIG. 14 shows predetermined relevance areas for a Feature Vector in document SOM 21 for beginner 420, intermediate 422 and expert 424 users that are determined in response to calculated Topic IQ. The dark nodes within the relevance radii indicate documents read by a user and the lighter colored nodes indicate documents that have not been read by a user. Although it is straightforward to detect that a user has opened a document this does not mean a user has read the document. System 10 calculates a numerical probability (ranging from 0 to 1) that a user has read a page of the document based on the number of page scrolls occurring per minute and the amount of time spent on that page. System 10 calculates the probability based on the assumptions, (a) a reader performing information gathering (studying material) reads at a minimum of reading rate of 180 words per minute (3 words per second), (b) performs an average of 5 page scrolls per minute (from observational analysis) and (c) a reader needs to visit each page to read the whole document.

System 10 advantageously determines a user has read a document using,

$$p = {\sum }_{i = 1}^{N} \frac{min ( t , 180 )}{180} \times \frac{min ( \frac{s}{t} , 5 )}{5}$$

Where N is the number of pages in a document, t is the time, in minutes, spent on page I and s is the number of scroll operations performed on page i. This probability determination advantageously encompasses readers that fall outside normal behavior.

Units 33 and 25 determine document and topic relevance and orders documents by their determined relevance. The relevance calculation takes into account the distance between a topic or document Feature Vector as well as the number of times the Document or Topic was added and removed by users. Documents are added and removed by users from their document list for a topic, while topics are added and removed by users from their list of topics. Document or topic relevance is calculated using,

$$relevance = \frac{1}{distance} \times ( 1 - \frac{removed}{added} )$$

Where distance is the distance between Feature Vectors, removed is the number of times the Document or Topic was removed by a user and added is the number of times the Document or Topic was added by a user.

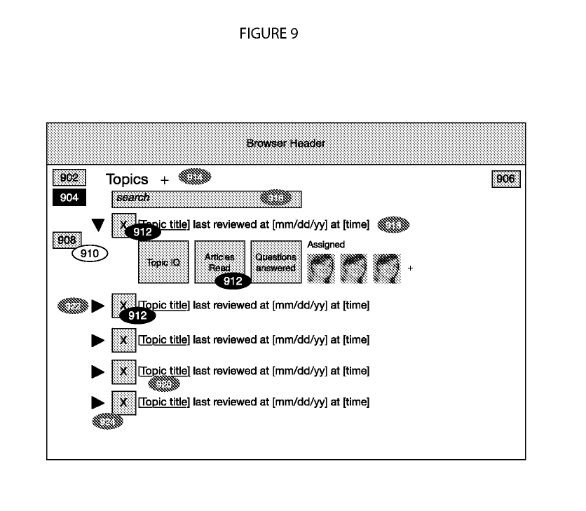

FIG. 9-11 show user interface (UI) image windows provided by the application 53 enabling user interaction to support system operation. FIG. 9 shows a UI image window supporting a document inbox and topic browser with item 902 providing a link to a global page and item 904 supporting access to a topic navigation page. Item 906 is a logout link and 908 provides a link to a library of stored documents. Item 910 indicates a total number of New Articles found by system 10 and items 912 indicates a number of new articles found per topic. A user is able to add a new topic link via item 914 and search for current topics in the Topic Browser via item 916. Further, item 918 enables a user to open a topic row to identify, topic IQ, articles read, questions answered and other users assigned to a topic. Item 920 provides a link to an article reader page and item 922 shows a minimized topic row with item 924 comprising a thumbnail image representing last reviewed or most recent article suggested by application 53.

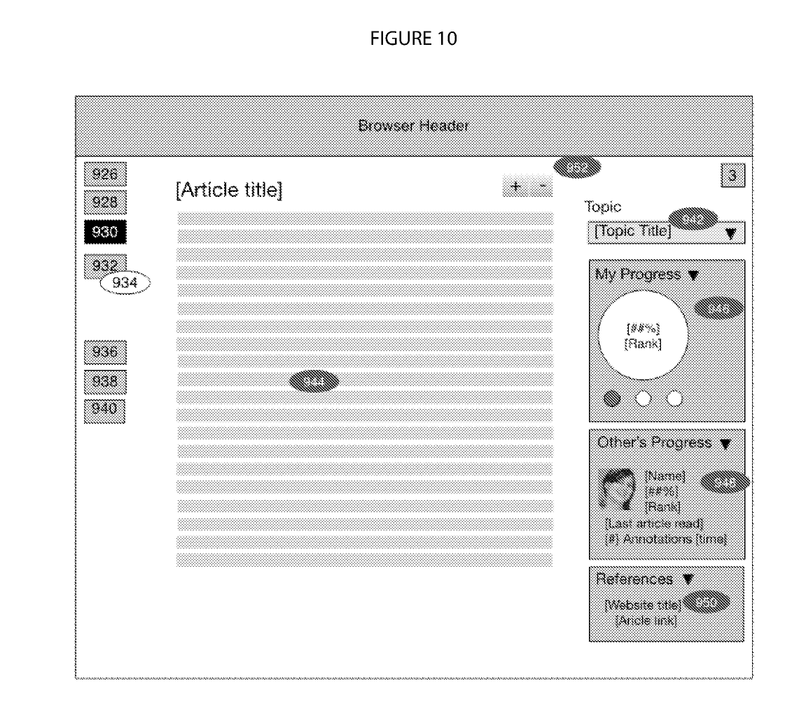

FIG. 10 shows a UI image window supporting reader 43 with item 926 providing a link to a global page, item 928 supporting access to a topic navigation page, item 930 providing a link to reader navigation and item 932 providing a link to a document library. The number of new articles found by system 10 is shown in item 934. Further, item 936 is a link to a page enabling a user to share a document and link 938 enables a user to access a document annotation tool. Item 940 enables access to reader mode display options and item 942 is an option list for assigning a topic category to a document. Document content with style and formatting characteristics omitted is shown in area 944 for a clean reading experience (Zen mode) and a collapsible user Topic IQ rating derived based on articles read, questions answered, volume of articles annotated and other user ratings of those annotations is shown in area 946. Item 948 shows topic IQ updates of other users assigned to a current topic, item 950 provides a link to an article original source and item 952 enables a user to add an article to a Library or My Collection or to move the article to trash.

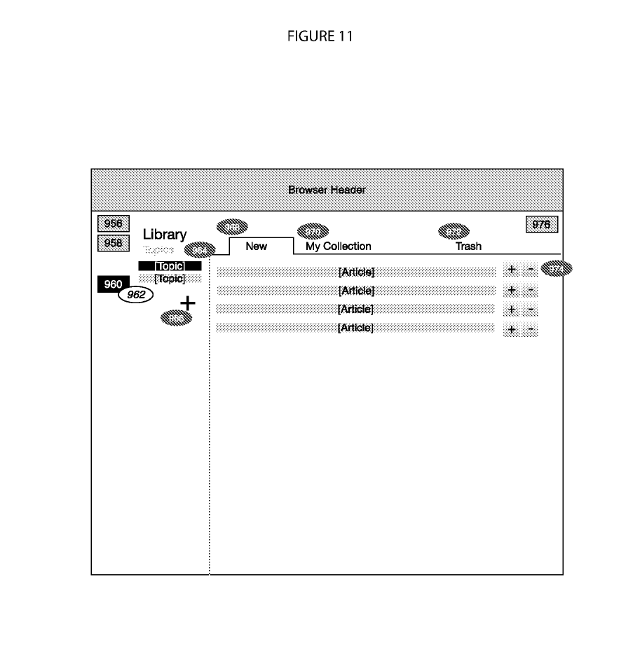

FIG. 11 shows a UI image window supporting a library with item 956 providing a link to a global page and item 958 supporting access to a topic navigation page. Item 976 is a logout link and 960 provides a link to articles found and added by a user to a topic. Item 962 indicates a total number of New Articles found by system 10 and items 964 provides a list of topics. A user is able to add a new topic via item 966. Also item 968 shows articles found for a topic. Further, item 970 shows user found or moved articles, item 972 shows deleted articles and item 974 enables a user to add an article to his collection or to delete an article.

In an example of operation, a user in a team needs to prepare a research report on a particular topic (topic A). The user and team install a browser plug compatible with a browser and studies social media, mainstream news articles, academic papers and identifies and marks a relevant article for further study via application 53. Server 12 queries document SOM 21 for articles within a specified distance (i.e. in the neighborhood) of the marked article and provides a list of the documents to application 53 within a specified distance of the topic. The user employs a shared dashboard for the team to view articles in inbox 41 and views and adds relevant documents of other team members to the user collection. The user selects a Learning Lab button and selects a first article to read in Zen Mode showing a plain text version of the article, removing distracting elements associated with web browsing. System 10 enables a user to highlight the text associated with an individual person and save the highlighted (or marked) text to a people profile database of the user in repository 31. System 10 also enables a user to highlight a text term (such as “food inflation”) in an article and adds the term and its definition automatically acquired from Wikipedia into a vocabulary builder in repository 31. The vocabulary builder saves terms and enables a user to explore definitions and reference them. The team is able to build a list of key terms and people data related to topic A using a specific dashboard for topic A and a user is able to add a comment using a social annotation feature requesting additional information enabling others to add information such as a link to a related document.

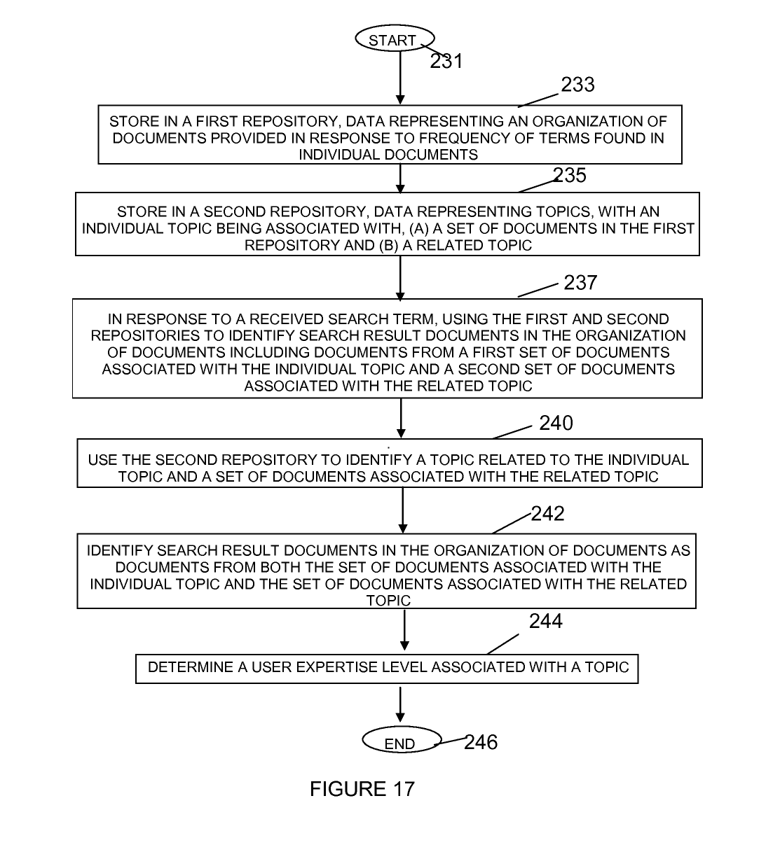

FIG. 17 shows a flowchart of a process used by a system for searching the Internet for a document. In activity 233 following the start at step 231, units 33 and 25 store in a first repository (SOM 21), data representing an organization of documents provided in response to frequency of terms found in individual documents. In activity, 235 units 33 and 25 store in a second repository (SOM 23), data representing topics, with an individual topic being associated with, (a) a set of documents in the first repository and (b) a related topic. In activity 237, in response to a received search term, units 33 and 25 use the first and second repositories to identify search result documents in the organization of documents including documents from a first set of documents associated with the individual topic and a second set of documents associated with the related topic. The organization of documents associates an individual document with data indicating a document spatial position within an array of elements representing documents, the spatial position being derived based on frequency of terms in the individual document and the second repository associates the individual topic with a position in the array. The spatial position of the individual topic within the array comprises a center of a set of documents associated with the individual topic. The set of documents associated with the individual topic is accumulated overtime in response to user selection, in a learning mode.

The array of elements representing documents comprises a two dimensional or three dimensional array of elements where distance between two elements representing first and second documents represents degree of relatedness of the first and second documents and the received search term comprises data indicating a document spatial position within an array of elements representing documents. In activity 240, units 33 and 25 use the second repository to identify a topic related to the individual topic and a set of documents associated with the related topic. Units 33 and 25 in activity 242, identify search result documents in the organization of documents as documents from both the set of documents associated with the individual topic and the set of documents associated with the related topic. Units 33 and 25 identify the related topic as having a spatial position within the array closest to the spatial position of the individual topic, the spatial position of the related topic corresponding to a center of a set of documents associated with the related topic. The center of the set of documents comprises at least one of, (a) a center of mass of elements representing individual documents of the set of documents, the elements being of equal weight and (b) a center of mass of elements representing individual documents of the set of documents, the elements being weighted in response to a relevance criteria and the first and second repositories may comprise one or more data repositories or databases.

The second repository includes a topic array comprising elements representing topics and associates an individual topic with a position in the topic array and an element in the topic array maps to a center of a set of documents associated with the individual topic in the array of elements representing documents of the first repository. Units 33 and 25, in response to a received search term, identify a first document using the first repository, identify a related topic comprising a topic related to the topic associated with the identified first document, using the second repository, identify a second document associated with the identified related topic and output data representing the search result documents including the first and second documents. In activity 244 units 33 and 25 determine a user expertise level associated with a topic in response to at least one of, (a) a number of documents read by the user, (b) a number of documents related to a topic and (c) a proportion determined using (a) and (b). The process of FIG. 17 terminates at activity 246.

The above-described embodiments can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The functions and process steps herein may be performed automatically or wholly or partially in response to user command. An activity (including a step) performed automatically is performed in response to executable instruction or device operation without user direct initiation of the activity. No claim element herein is to be construed under the provisions of 35 U.S.C. 112, sixth paragraph, unless the element is expressly recited using the phrase “means for.” A “processor” as used herein comprises, a computer system circuit and device operating in response to instruction and is not just software.

The architecture of FIG. 1 is not exclusive. Other architectures may be derived in accordance with the principles of the invention to accomplish the same objectives. Further, the functions of the elements of system 10 of FIG. 1 and the process steps employed may be performed in whole or in part within the programmed instructions of a microprocessor.

What is claimed is:

1. A system for searching for and organizing documents, comprising:
at least one computer system including,
a first repository of data representing an organization of documents provided in response to frequency of terms found in individual documents;
a second repository of data representing topics, with an individual topic being associated with,
(a) a set of documents in the first repository and
(b) a related topic;
a processor configured to, in response to a received search term, use the first and second repositories to identify search result documents in said organization of documents including documents from a first set of documents associated with said individual topic and a second set of documents associated with said related topic.

2. A system according to claim 1, wherein
said organization of documents associates an individual document with data indicating a document spatial position within an array of elements representing documents, said spatial position being derived based on frequency of terms in said individual document and
said second repository associates said individual topic with a position in said array.

3. A system according to claim 2, wherein
the spatial position of said individual topic within said array comprises a center of a set of documents associated with said individual topic.

4. A system according to claim 3, wherein
said set of documents associated with said individual topic is accumulated overtime in response to user selection, in a learning mode.

5. A system according to claim 2, wherein
said array of elements representing documents comprises a two dimensional or three dimensional array of elements where distance between two elements representing first and second documents represents degree of relatedness of the first and second documents and
said received search term comprises data indicating a document spatial position within an array of elements representing documents.

6. A system according to claim 1, wherein
said processor,
uses said second repository to identify
a topic related to said individual topic and
a set of documents associated with said related topic and
identifies search result documents in said organization of documents as documents from both the set of documents associated with said individual topic and the set of documents associated with said related topic.

7. A system according to claim 3, wherein
said processor identifies said related topic as having a spatial position within said array closest to the spatial position of said individual topic, the spatial position of said related topic corresponding to a center of a set of documents associated with said related topic.

8. A system according to claim 3, wherein
said center of said set of documents comprises at least one of, (a) a center of mass of elements representing individual documents of said set of documents, said elements being of equal weight and (b) a center of mass of elements representing individual documents of said set of documents, said elements being weighted in response to a relevance criteria and
the first and second repositories may comprise one or more data repositories or databases.

9. A system according to claim 2, wherein
said second repository includes a topic array comprising elements representing topics and associating an individual topic with a position in the topic array and
an element in said topic array maps to a center of a set of documents associated with said individual topic in the array of elements representing documents of said first repository.

10. A system according to claim 1, wherein
said processor, in response to a received search term,
identifies a first document using the first repository,
identifies a related topic comprising a topic related to the topic associated with the identified first document, using the second repository,
identifies a second document associated with the identified related topic and
outputs data representing said search result documents including the first and second documents.

11. A system for searching for and organizing documents, comprising:
at least one computer system including,
a first repository of data representing an organization of documents provided in response to frequency of terms found in individual documents;
a second repository of data representing topics, with an individual topic being associated with,
(a) a set of documents in the first repository and
(b) a related topic;
a processor configured to, in response to a received search term,
identify a first document using the first repository,
identify a related topic comprising a topic related to the topic associated with the identified first document, using the second repository,
identify a second document associated with the identified related topic and
output data representing said search result documents including the first and second documents.

12. A system according to claim 11, wherein
said organization of documents associates an individual document with data indicating a document spatial position within an array of elements representing documents, said spatial position being derived based on frequency of terms in said individual document and
said second repository associates said individual topic with a position in said array.

13. A system according to claim 11, wherein
said second repository includes a topic array comprising elements representing topics and associating an individual topic with a position in the topic array and
and an element in said topic array maps to a center of a set of documents associated with said individual topic in the array of elements representing documents of said first repository.

14. A method for searching for and organizing documents, comprising the activities of:
storing in a first repository, data representing an organization of documents provided in response to frequency of terms found in individual documents;
storing in a second repository, data representing topics, with an individual topic being associated with,
(a) a set of documents in the first repository and
(b) a related topic;
in response to a received search term, using the first and second repositories to identify search result documents in said organization of documents including documents from a first set of documents associated with said individual topic and a second set of documents associated with said related topic.

15. A method according to claim 14, wherein
said organization of documents associates an individual document with data indicating a document spatial position within an array of elements representing documents, said spatial position being derived based on frequency of terms in said individual document and
said second repository associates said individual topic with a position in said array.

16. A method according to claim 15, wherein
the spatial position of said individual topic within said array comprises a center of a set of documents associated with said individual topic and
said set of documents associated with said individual topic is accumulated overtime in response to user selection, in a learning mode.

17. A method according to claim 15, wherein
said array of elements representing documents comprises a two dimensional or three dimensional array of elements where distance between two elements representing first and second documents represents degree of relatedness of the first and second documents and including the activity of,
identifying said related topic as having a spatial position within said array closest to the spatial position of said individual topic, the spatial position of said related topic corresponding to a center of a set of documents associated with said related topic.

18. A method according to claim 14, including the activities of,
using said second repository to identify
a topic related to said individual topic and
a set of documents associated with said related topic and
identifying search result documents in said organization of documents as documents from both the set of documents associated with said individual topic and the set of documents associated with said related topic.

19. A method according to claim 15, wherein
said second repository includes a topic array comprising elements representing topics and associating an individual topic with a position in the topic array and
and an element in said topic array maps to a center of a set of documents associated with said individual topic in the array of elements representing documents of said first repository.

20. A method according to claim 14, including the activities of,
in response to a received search term,
identifying a first document using the first repository,
identifying a related topic comprising a topic related to the topic associated with the identified first document, using the second repository,
identifying a second document associated with the identified related topic and
outputting data representing said search result documents including the first and second documents.

21. A method according to claim 14, including
determining a user expertise level associated with a topic in response to at least one of, (a) a number of documents read by the user, (b) a number of documents related to a topic and (c) a proportion determined using (a) and (b).
